(19) United States
(12) Patent Application Publication
(10) Pub. No.: US 2025/0020951 A1
(43) Pub. Date: Jan. 16, 2025

(54) PHOTONIC CIRCUIT

(71) Applicant: Q.ant GmbH, Stuttgart (DE)

(72) Inventors: Robert RÖLVER, Calw (DE); Michael FÖRTSCH, Ansbach (DE); Franz LEIBL, Dresden (DE)

(21) Appl. No.: 18/898,717

(22) Filed: Sep. 27, 2024

Related U.S. Application Data
(63) Continuation of application No. PCT/EP2023/055907, filed on Mar. 8, 2023.

(30) Foreign Application Priority Data
Mar. 30, 2022 (DE) 10 2022 203 109.1

(51) Int. Cl. G02F 1/035

(52) U.S. Cl. CPC G02F 1/035

(57) ABSTRACT

A photonic circuit includes a substrate, a plurality of waveguides mounted on the substrate, and a plurality of modulators for modulating light guided in the waveguides. The plurality of waveguides is formed from an electro-optically active material. The modulators are electro-optical modulators. Each modulator includes an electrode for generating an electrical field in a portion of a respective waveguide. Each modulator includes a conductor track for feeding an electrical modulation signal to the electrode. The photonic circuit is configured to reduce stray electrical fields in the plurality of waveguides by feeding the electrical modulation signals to the electrodes.

### CROSS REFERENCE TO RELATED APPLICATIONS

This application is a continuation of International Application No. PCT/EP2023/055907 (WO 2023/186477 A1), filed on Mar. 8, 2023, and claims benefit to German Patent Application No. DE 10 2022 203 109.1, filed on Mar. 30, 2022. The aforementioned applications are hereby incorporated by reference herein.

### FIELD

Embodiments of the present invention relate to an (integrated) photonic circuit including a substrate and a plurality of waveguides mounted on the substrate.

### BACKGROUND

Integrated photonic circuits enable the implementation of novel computing hardware architectures such as neuromorphic computing or photonic quantum computing. In integrated photonic circuits the light that is coupled into the photonic circuit (into a chip) using suitable measures is typically guided in monolithically integrated waveguides on large-area substrates and is caused to interfere with the light guided in other waveguides by means of (adjustable) beam splitters. The (adjustable) beam splitters may, for example, be Mach-Zehnder interferometers. The degree of interference at a respective crossing point at which an (adjustable) beam splitter is arranged can be adjusted by influencing the phase position of the two photons guided in the waveguides. Photonic circuits therefore usually require a large number of modulators, in particular in the form of phase modulators.

The paper “Silica-on-Silicon Waveguide Quantum Circuits”, Alberto Polini et al., Science, vol. 320, p. 646 describes integrated photonic circuits based on “silica-on-silicon” waveguides, i.e., waveguides made of SiO₂, which are applied to a silicon substrate. Such a photonic circuit may be used, for example, to enable two-photon quantum interference.

An example of an integrated photonic circuit using silicon nitride as the waveguide material is described in the paper “8×8 reconfigurable quantum photonic processor based on silicon nitride waveguides”, C. Taballione et al., Optics Express, vol. 27, 26843 (2019). In this paper, a thermo-optical phase modulator is used to adjust the phase position of a respective adjustable beam splitter in the form of a Mach-Zehnder interferometer.

The paper “Quantum circuits with many photons on a programmable nanophotonic chip”, J. M. Arrazola et al., Nature 591, 54-60 (2021) describes a quantum circuit in the form of a programmable chip that may be used, among other things, to obtain a “Gaussian boson sampler” (GBS). The integrated optical circuit uses silicon nitride waveguides and thermo-optical phase modulators or phase shifters.

The paper “An Integrated Low-voltage Broadband Lithium Niobate Phase Modulator” by Tianhao Ren et al., IEEE Photonics Technology Letters, vol. 31, no. 11, pp. 889-892 describes an electro-optical phase modulator in which a thin layer of lithium niobate is used for phase modulation. A high-frequency alternating field is applied to the layer for phase modulation.

### SUMMARY

Embodiments of the present invention provide a photonic circuit. The photonic circuit includes a substrate, a plurality of waveguides mounted on the substrate, and a plurality of modulators for modulating light guided in the waveguides. The plurality of waveguides is formed from an electro-optically active material. The modulators are electro-optical modulators. Each modulator includes an electrode for generating an electrical field in a portion of a respective waveguide. Each modulator includes a conductor track for feeding an electrical modulation signal to the electrode. The photonic circuit is configured to reduce stray electrical fields in the plurality of waveguides by feeding the electrical modulation signals to the electrodes.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic representation of a photonic circuit in the form of a photonic quantum computer with a network of waveguides according to some embodiments;

FIG. 2 shows a schematic representation of the configuration of a crossing point of the network of FIG. 1 with a Mach-Zehnder interferometer and with several phase modulators according to some embodiments;

FIGS. 3a and 3b show representations of one of the phase modulators of FIG. 2, which takes the form of an electro-optical (phase) modulator and has an electrode for generating an electrical field in a locally limited portion of a waveguide and a conductor track for feeding an electrical modulation signal to the electrode, according to some embodiments;

FIG. 4 shows a cross-sectional representation of the photonic circuit in which a metalization layer serving as a shield is embedded in an electrically insulating layer to protect the waveguides from stray electrical fields, according to some embodiments;

FIGS. 5a and 5b show representations of a photonic circuit in which a locally limited electrically conductive volume region is formed in the region of a respective electrode between one of the waveguides and the substrate, according to some embodiments;

FIGS. 6a and 6b show representations of a photonic circuit in which a wiring component in the form of a printed circuit board, spaced from the substrate, is connected to a contact surface for contacting an electrode of a respective electro-optical modulator, according to some embodiments; and

FIGS. 7a and 7b show a representation of a photonic circuit in which the wiring component in the form of the printed circuit board serves to contact a contact surface formed on the back side of the substrate, which contact surface is part of an electrode in the form of a metalization layer that extends into a recess in the substrate up to an electrically conductive volume region of the substrate, according to some embodiments.

### DETAILED DESCRIPTION

Embodiments of the present invention provide a photonic circuit that enables fast switching times and maximally interference-free modulation of the light guided in the waveguides.

According to some embodiments, the photonic circuit includes a substrate, a plurality of waveguides mounted on the substrate, and a plurality of modulators, in particular phase modulators, for modulating light guided in the waveguides, typically in the form of individual photons or photon pulses with a countable number of photons. The waveguides are formed from an electro-optically active material, the modulators take the form of electro-optical modulators which each have an electrode for generating an electrical field in a portion of a particular waveguide and each have a conductor track for feeding an electrical modulation signal to the electrode, and the photonic circuit is configured to reduce, preferably to avoid, stray electrical fields caused in the waveguides by feeding the electrical modulation signals.

In the photonic circuit described here, the waveguides are made of an electro-optically active waveguide material, for example LiNbO₃ or KTP. Compared to the materials typically used for the manufacture of waveguides, such as Si, SiO₂ or SiN (see above), electro-optically active waveguide materials offer the possibility of modulation by electro-optical modulators, for example by electro-optical phase modulators. This leads to significantly faster switching times and the possibility of enabling photonic quantum computers with significantly higher scaling.

Modulation of the light guided in a respective waveguide is achieved by applying an electrical field in a defined region or portion of the waveguide. Due to the electro-optical effect in the electro-optically active material of the waveguide, this electrical field leads to a change in the refractive index of said electro-optically active material. The strength of this refractive index modulation is proportional to the strength of the applied electrical field. The refractive index modulation leads to a modulation of the phase of the light guided in the waveguide and therefore to a phase shift compared to light guided in a waveguide without such modulation.

When electrical modulation signals are fed to the electro-optical modulators, more precisely to electrodes that serve to generate an electrical field in a particular portion of a waveguide, stray or interference electrical or electromagnetic fields are generated along the voltage-carrying metallic conductor tracks. These unwanted stray fields may extend to the waveguides and lead to unwanted refractive index changes in the electro-optically active material. A photonic circuit typically has a very large number of electro-optical modulators, which may be on the order of several 100,000, for example. Due to the complexity of metallic contacting over a corresponding number of conductor tracks, it is therefore essential to take suitable measures to prevent unwanted stray electrical fields in the region of the waveguides or to minimize them to the greatest possible extent.

In one embodiment, the photonic circuit has an electrically conductive shield for shielding the waveguides from the stray electrical fields, wherein the shield is preferably arranged between a wiring portion of a respective conductor track and the waveguides. The electrical modulation signal used to drive a respective electro-optical modulator is typically a DC voltage with a time-varying voltage value or optionally a low-frequency AC voltage. The electrically conductive shield is typically grounded and shields the waveguides from a respective conductor track, more precisely from stray fields generated by the conductor track, for example from a wiring portion of the conductor track. A wiring portion is understood to mean a portion of the conductor track which leads away from the portion of the waveguide on which a respective electro-optical modulator is arranged on the substrate, typically along a plane parallel to the front side of the substrate, and extends to a central wiring point which is connected to a signal source for generating the electrical modulation signals, typically to a suitably configured voltage source.

In a further development of this embodiment, the waveguides are covered by an electrically insulating layer and the shield is embedded in the electrically insulating layer and preferably takes the form of a metalization layer. In this case, the shield is arranged between the plane at the front side of the substrate on which the waveguides are arranged and a typically flat surface on the top side of the electrically insulating layer on which the wiring portions of the conductor tracks run. The shield is usually flat and takes the form of a metalization layer, i.e., of a thin metal layer. In this way, a metalization plane—usually grounded—is arranged between the plane in which the waveguides are arranged and the plane in which wiring of the conductor tracks takes place. As a result of being embedded in the electrically insulating layer, the electrically conductive shield is electrically insulated from the electrodes and from the wiring portions of the conductor tracks. The grounded metalization layer prevents stray electrical fields from reaching the waveguides. The thickness of the electrically insulating layer starting from the top side of the substrate is typically at least twice the height of a respective waveguide, which is likewise measured from the top side of the substrate.

In a further development, the shield has a hole in the region of the electrode of a respective electro-optical modulator through which runs the respective conductor track, or more precisely a contact portion of the conductor track. The electrically conductive shield is only opened directly above or adjacent to the respective waveguide or modulator contact in order to enable electrically insulated passage of the conductor track from the electrode to the wiring portion. The contact portion of the conductor track typically extends from the wiring portion on the top side of the electrically insulating layer to the plane with the waveguides on the front side of the substrate.

In a further embodiment, the substrate is electrically conductive. In this case, the electrically conductive substrate may serve as a counter electrode of the electro-optical modulator. In this case, the substrate is at a different electrical potential than the electrode of the electro-optical modulator in order to generate an electrical field in the portion of the waveguide arranged between the electrode and the substrate to modulate the light propagating through the waveguide. In particular, the substrate may be grounded, i.e., be at ground potential. The same applies to the shield, i.e., the shield and the substrate may be connected together electrically conductively and be jointly at ground potential. The electrically conductive substrate may, for example, be a doped semiconductor material, e.g., doped silicon, or indeed doped SiC, GaAs, GaN, etc.

In a further development of this embodiment, an insulator layer is applied to a side of the substrate facing the waveguides, which insulator layer extends between the waveguides and the substrate and preferably surrounds the waveguides. The insulator layer, which may consist for example of SiO₂, typically has a refractive index that is lower than the refractive index of the electro-optically active material of the waveguide in order to improve guidance of light in the waveguide. The insulator layer typically has a significantly lower thickness or height than the respective waveguides. Accordingly, the insulator layer does not completely fill the gaps between the waveguides applied to the substrate, i.e., the waveguides are not embedded in the insulator layer. In addition to the insulator layer, the above-described electrically insulating layer whose thickness is greater than the height of the waveguides (see above) may be applied to the substrate. However, it is also possible for the insulator layer described here and the electrically insulating layer to be a single (thick) layer of an insulating material into which the waveguides are embedded.

In a further development of this embodiment, the insulator layer or a further insulator layer applied between the substrate and the insulator layer has an electrically conductive region which extends between a particular portion of the waveguide on which the electrode is arranged and the substrate. As described above, the insulator layer surrounding the respective waveguide serves to improve guidance of the light in the waveguide and for this purpose requires a suitable refractive index. In order to create the electrically conductive region, it may be advantageous to use a further insulator layer that is not directly adjacent to the waveguide and whose refractive index is therefore not subject to any requirements. However, it is also possible for no further insulator layer to be present and for the insulator layer adjacent to the waveguide to have the electrically conductive region(s).

The further insulator layer may, for example, be an undoped semiconductor layer, e.g., of silicon, which is doped in the electrically conductive region. The electrically conductive region or volume of the insulator layer is typically substantially confined to a region of the insulator layer located in a gap between the portion of the waveguide in which the electrical field is generated and the substrate. Outside this region, the insulator layer is typically not electrically conductive.

By grounding the substrate, e.g., in the form of a (doped) silicon wafer, using an electrical contact, e.g., on the back side thereof, the electrically conductive regions of the insulator layer or the further insulator layer are also grounded, while in all other regions the grounding potential is further away from the voltage-carrying electrodes of the respective electro-optical modulators or the conductor tracks due to the insulator layer or the further insulator layer, which is why any stray electrical field present in the electrically insulating regions of the insulator layer or the further insulator layer is significantly smaller and the effect of unwanted modulation of the light guided in the waveguides is significantly reduced.

Such an insulator layer may be produced, for example, by first epitaxially applying an undoped semiconductor layer to the substrate. Appropriate masking (e.g., with shadow masks or lithographically defined photoresist structures) during ion implantation of suitable dopants makes it possible deliberately to make only those regions of the insulator layer electrically conductive at which the portions of the waveguides with the electrodes are located. Alternatively, it is possible to create the local electrically conductive volume region in the insulator layer by locally limited metalization. In this case, the insulator layer may be removed in the locally limited region in order to introduce metalization. It is also possible to leave out the locally limited regions when depositing the insulator layer for subsequent introduction of metalization into the insulator layer.

In a further embodiment, the insulator layer or the further insulator layer between the waveguide and the substrate has a thickness of between 1 μm and 50 μm, preferably between 5 μm and 20 μm, for example around 10 μm. As described above, it is advantageous for the electrically conductive substrate to be at a comparatively large distance from the respective waveguide, since in this way the stray electrical fields generated in the respective waveguide turn out very small.

In a further development, at least one conductor track—typically in a portion in which no electrode is arranged—is guided over at least one of the waveguides. In the embodiment described above, the electrically conductive substrate is at a sufficient distance from a respective conductor track to allow conductor tracks to be guided over the waveguides without significant stray electrical fields occurring in the respective waveguide in the process.

In a further embodiment, the substrate has a contact surface in the region of a respective electrode for electrical contacting with a contact portion of a respective conductor track, wherein the contact portion extends from a wiring component spaced apart from the substrate, in particular from a printed circuit board or card, to the contact surface. In this embodiment, wiring of the photonic circuit takes place at an (external) wiring component that is spaced apart from the substrate and may take the form, for example, of a printed circuit board or card. In the event that the wiring component is sufficiently spaced from the substrate or the waveguides, the interference fields induced in the waveguides by the wiring portions are small. The contact portions may take form of contact pins which contact the contact surfaces but are not firmly connected to the contact surfaces. Alternatively, the contact portions may be firmly connected to the contact surfaces, for example via soldering points or the like.

In a further development, wiring portions of the conductor tracks run on a side of the wiring component facing away from the substrate. In this case, the contact portions of the conductor tracks are passed through the wiring component, typically in the form of the printed circuit board/card, in order to contact the contact portions on the substrate. It is advantageous for the wiring portions of the conductor tracks to extend on the side of the circuit board remote from the substrate, since the electrically insulating circuit board may serve as a shield in this case. The wiring portions of the conductor tracks may, for example, be routed on the printed circuit board to a common, central connection point.

In a further development, the contact surfaces are mounted on a side of the substrate facing the waveguides. In this case, the contact surfaces are typically arranged adjacent to a respective electrode on the substrate. The electrodes and the contact surfaces here typically take the form of common metalization.

In an alternative further development of the embodiment described above, the contact surfaces are formed on a side of the substrate remote from the waveguides. In this case, the external wiring takes place on the back side of the substrate or wafer, as described in more detail below:

In a further development, the substrate is electrically insulating and has (locally limited) electrically conductive volume regions which are connected to a respective contact surface on the side of the substrate remote from the waveguides. The electrically conductive volume regions of the substrate are located at the positions on the substrate at which electro-optical modulation is to take place. The electrically conductive volume regions may be created by doping them in an otherwise undoped semiconductor substrate and thus making them conductive. Alternatively, the electrically conductive volume regions may optionally also be formed by metalizing the electrically insulating substrate.

In a further embodiment, the electrically conductive volume regions adjoin recesses which extend into the substrate from the side remote from the waveguides, wherein the electrodes are preferably formed by a metalization layer extending from a respective contact surface to a respective electrically conductive volume region. The recesses may be introduced into the substrate in lithographically defined manner using suitable etching processes (e.g., Deep Reactive Ion Etching, DRIE). Etching occurs to the depth of the doped volume regions. By subsequently metalizing the recesses, the locally limited electrodes may be defined, these being contacted with a respective conductor track of the wiring component by way of the contact surfaces.

In order to form a (common) counter electrode for the electro-optical modulators, the waveguides or the side of the substrate facing the waveguides may first be completely coated with an electrically insulating material, e.g., with SiO₂ or with SiN, and then metalized over the entire surface. In this case, the full-surface metalization layer is typically grounded and forms the counter electrode for the electrodes of the respective electro-optical modulators embodied as described above.

Further advantages of the embodiments of the invention are revealed by the description and the drawings. Likewise, the features mentioned above and those yet to be presented may be used in each case alone or jointly in any desired combinations. The embodiments shown and described should not be understood as an exhaustive list.

In the following description of the drawings, identical reference signs are used for identical or functionally identical components.

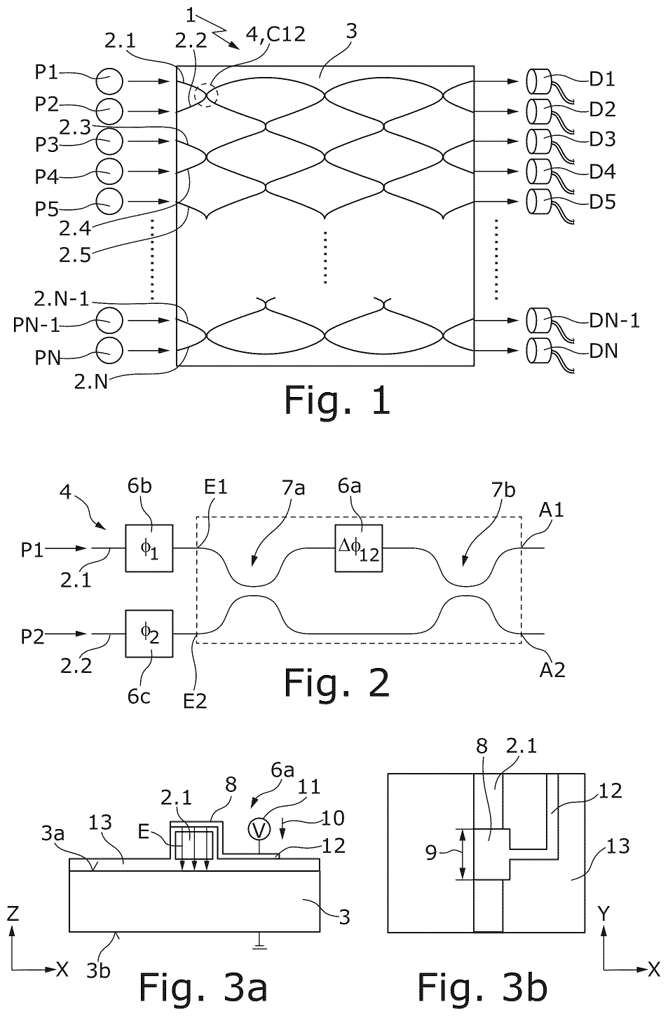

FIG. 1 is a highly schematic representation of an example of a photonic circuit 1 which has a substrate 2, on the top side of which are arranged a plurality of waveguides 2.1-2.N. As is indicated highly schematically in FIG. 1, light in the form of N individual photons P1-PN, more precisely in the form of photon pulses with countably few photons of the same wavelength, is simultaneously coupled into a particular waveguide 2.1-2.N of the photonic circuit 1. The waveguides 2.1-2.N form a network in which two adjacent waveguides 2.1-2.N are in each case coupled to one another at multiple crossing points 4, wherein the crossing points 4 form a regular grid. The number of photons that have passed through a particular waveguide 2.1-2.N during transmission through the network are counted at a respective output of the photonic circuit 1 using a plurality n of detectors D1-DN. The number N of inputs to the photonic circuit 1 may be the same as the number N of outputs, but this is not necessarily the case.

The photonic circuit 1 shown in FIG. 1 is a “Gaussian boson sampler”, which constitutes a specific form of photonic quantum computer with reference to which the complexity of a photonic circuit 1 may be readily explained. The Gaussian boson sampler is able to calculate the Hafnian of square matrices with N×N entries. For this purpose, the photon distribution of the photons P1-PN arriving at the outputs or at the detectors D1-DN is counted, which corresponds to the permanent of the so-called coupling matrix. The calculation of Hafnian complex matrices is not possible using classical computers, and constitutes what it is called a #P-Hard problem.

The matrix whose Hafnian is to be calculated is programmed by setting a phase shift ΔΦ at a respective crossing point 4 at which the light P1 and the light P2 guided in two adjacent waveguides 2.1, 2.2 interfere with each other, as shown in FIG. 2 by way of example for a crossing point 4 of the photonic circuit 1 shown in FIG. 1. At the crossing point 4, in the example shown in FIG. 2, the coupling probability c1₂ (cf. FIG. 1) between the two inputs and the two outputs of a Mach-Zehnder interferometer 5 is adjusted using a phase modulator 6a, which for this purpose specifies an adjustable phase shift ΔΦ₁₂. The four entries a₁₁, a₁₂, a₂₁ and a₂₂ of a 2×2 matrix, whose permanent is to be calculated with the photonic circuit 1, may be easily expressed in analytical form by the coupling probability c₁₂ expressed at crossing point 4. In the case of a 3×3 matrix, the analytical mathematical description of the problem and the analytical relationship between, in this case, the three coupling probabilities at three crossing points and the nine entries of the 3×3 matrix are already significantly more complex. The complexity of calculating the permanent increases sharply with increasing N and is not possible using classical computers, which is why the photonic circuit 1 is used to determine the permanent.

As may be seen in FIG. 2, for coupling at the crossing point 4, the two photons P1, P2 propagating in the respective first and second waveguides 2.1, 2.2 are first brought into phase using two further phase modulators 6b, 6c by adjusting the respective phase Φ₁, Φ₂ of the photons P1, P2 in a such way that they arrive at the Mach-Zehnder interferometer 5 at the same time. It is understood that a single additional phase modulator may be sufficient for this purpose. As is generally customary, the Mach-Zehnder modulator 5 has two beam splitters 7a, 7b, between which the phase modulator 6a is arranged. The phase modulator 6a or the phase shift ΔΦ determines which portion of the light or photons P1, P2 is transferred from the first input E1 of the Mach-Zehnder interferometer 5 to the first output A1, from the first input E1 to the second output A2, from the second input E2 to the first output A1 and from the second input E2 to the second output E2 of the phase modulator 6a. Since three phase modulators 6a-c are required for each crossing point 4, a Gaussian boson sampler requires a 3×N×N phase modulators to calculate the permanent of an N×N matrix. Assuming that a real advantage of the Gaussian boson sampler over classical computers in certain optimization problems can only be achieved from a size of N=500, this results in a number of 750,000 phase modulators that need to be supplied with corresponding modulation signals in order to set the desired phase shift in each case.

In the photonic circuit 1 described here, the phase modulators 6a-c take the form of electro-optical phase modulators. FIGS. 3a and 3b show, by way of example, a phase modulator 6a of this type which serves to adjust the phase difference in the case of the Mach-Zehnder interferometer 5 shown in FIG. 2. The phase modulator 6a has a flat electrode 8 which is mounted on the top side of the waveguide 2.1 and extends in the longitudinal direction of the waveguide 2.1 along a locally limited portion 9 in which an electrical field E is generated in the material of the waveguide 2.1 with the aid of the electrode 8. The length of portion 9 is on the order of 50 μm to 500 μm. The material of the waveguide 2.1 is an electro-optically active material, for example lithium niobate (LiNbO₃) or potassium titanyl phosphate (KTP). With such a material, the applied electrical field E leads to a change in the refractive index in the waveguide 2.1 due to the electro-optical effect, causing a phase shift ΔΦ. The strength of the refractive index modulation is proportional to the strength of the electrical field E generated in the waveguide 2.1. The strength of the electrical field E in the waveguide 2.1 is adjusted with the aid of an electrical modulation signal 10, which is provided in the form of a DC voltage or an electric potential V by a signal generator 11. The electro-optical phase modulator 6a has an electrical conductor track 12 for feeding the electrical modulation signal 10 to the electrode 8, said electrical conductor track starting from the electrode 8 and running along a side 3a (front side) of the substrate 3 on which the waveguides 2.1-2.N also run.

In the example shown in FIGS. 3a and 3b, the substrate 3 consists of an electrically conductive semiconductor substrate in the form of doped silicon, which serves as a counter electrode in the generation of the electrical field E and is connected to ground potential at its back side remote from the waveguides 2.1-2.N. The substrate 3 may alternatively be formed from, for example, SiC, GaAs, GaN, etc. In the example shown in FIGS. 3a and 3b, an insulator layer 13 is applied to the front side 3a of the substrate 3, which insulator layer extends flat on the front side 3a of the substrate 3 and also surrounds a respective waveguide 2.1-2.N. The insulator layer 13 has a lower refractive index than the waveguide material, which enables the photons P1-PN to be guided in the respective waveguide 2.1-2.N. The material of the insulator layer 13 may be SiO₂, SiN or Al₂O₃, for example. The insulator layer 13 may be applied to the substrate 3, for example, by chemical vapor deposition (CVD), by sputter deposition, or by atomic layer deposition (ALD).

The problem with the electro-optical modulator 6a shown in FIGS. 3a and 3b is that feeding of the electrical modulation signal 10 to the electrode 8 via the electrical conductor track 12 and via a plurality of corresponding electrical or metallic conductor tracks to the other electro-optical modulators of the photonic circuit 1 may lead to unwanted stray or interference electrical fields in the waveguides 2.1-2.N, which lead to unwanted refractive index shifts in the nearby waveguide portions. Due to the complexity of contacting approximately 750,000 electro-optical modulators metallically over the substrate 3 overall, it is necessary to use suitable measures to suppress these unwanted interference electrical fields.

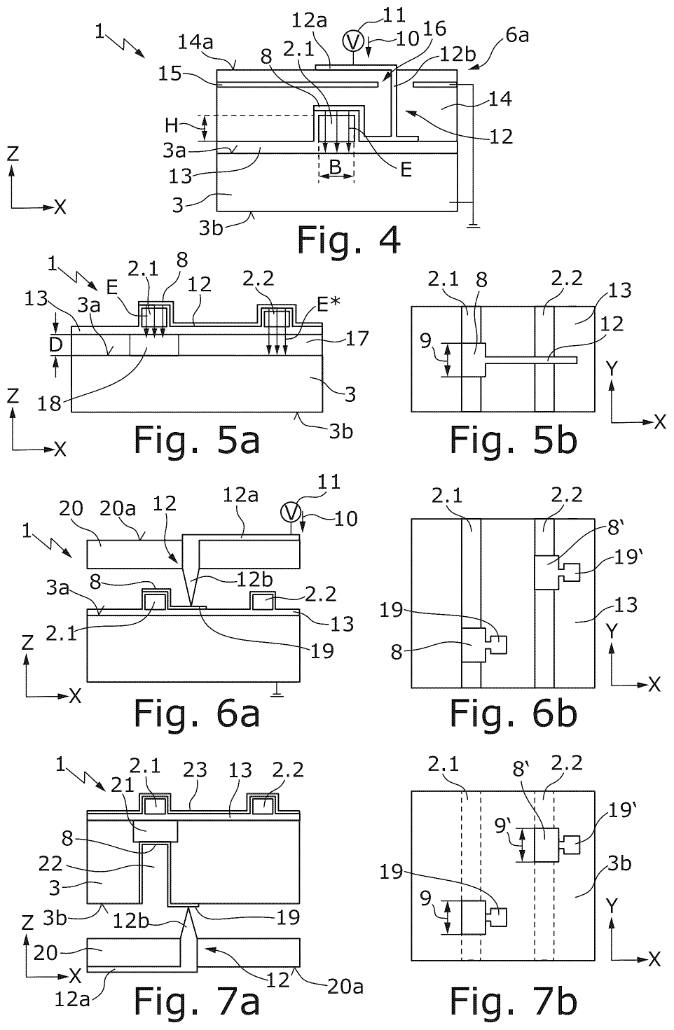

FIG. 4 shows a first possibility for suppressing or reducing stray electrical fields using the example of an electro-optical modulator 6a, which is basically constructed like the electro-optical modulator 6a shown in FIGS. 3a and 3b. The electro-optical modulator 6a of FIG. 4 additionally has an electrically insulating layer 14 with a comparatively large thickness which corresponds to at least twice, in the example shown approximately three times, the height H of the waveguide 2.1. The height H of a respective waveguide 2.1 is typically in the range between approx. 300 nm and approx. 10 μm, in the example shown approx. 650 nm. In the example shown, the width B of the waveguide 2.1 corresponds approximately to the height H of the waveguide 2.1 and lies within the same value range, i.e., is also between approx. 300 nm and approx. 10 μm, for example approx. 650 nm. The material of the electrically insulating layer 14 may be SiO₂, SiN or Al₂O₃, for example. If, unlike as shown in FIG. 4, the material of the insulator layer 13 and the material of the electrically insulating layer 14 match, the two together form an electrically insulating layer 13, 14 in which the waveguides 2.1-2.N are embedded.

As may also be seen from the sectional representation of a sub-region of the substrate 3 shown in FIG. 4, an electrically conductive shield in the form of a flat metalization layer 15, which extends above the waveguides 2.1-2.N and is spaced apart therefrom, is embedded in the electrically conductive layer 14. In the example shown, the metalization layer 15 forms a plane which separates the plane at the front side 3a of the substrate 3, on which the waveguides 2.1-2.N are mounted, from a wiring plane which is located at a top side 14a of the electrically insulating layer 14 and along which a respective wiring portion 12a of the respective conductor track 12 runs. As may also be seen from FIG. 4, both the metalization layer 15 and the substrate 3 are grounded, i.e., both are at the same electrical (ground) potential. The arrangement of the grounded metalization layer 15 between the respective wiring portion 12a of the conductor track 12 or between the wiring plane and the plane with the waveguides 2.1-2.N at the front side 3a of the substrate 3 prevents interference electrical fields coming from the wiring portions 12a of the conductor tracks 12 from reaching the plane with the waveguides 2.1-2.N. This is advantageous because in the (re-)wiring plane the wiring portions 12a of the conductor tracks 12 are typically guided to a central contact region where the connection to a signal generator is made, such that the length of the wiring portions 12 in the wiring plane at which the interference electrical fields can be generated is comparatively large.

As may also be seen from FIG. 4, the metalization layer 15 is perforated in the region or in the vicinity of a respective electrode 8 of the electro-optical modulator 6a, i.e., it has a hole 16 in the form of an opening through which a connecting portion 12b of the conductor track 12 runs in order to connect the electrode 8 to the wiring portion 12a of the conductor track 12 at the top side 14a of the electrically insulating layer 14. Since a respective hole 16 in the metalization layer is limited to a small region of the surface in the vicinity of the respective electrode 8, interference electrical fields can be effectively suppressed by way of the metalization layer 15. Both the metalization layer 15 and the electrode 8 and the respective conductor track 12 are metalizations in the form of thin layers of metal, for example of Au, Al, Ti, Ag, Cr, etc., which may be produced, for example, by sputter deposition, electron beam evaporation, atomic layer deposition, lithographic patterning using lift-off technology, ion beam etching, wet chemical etching, laser ablation patterning and so on. In particular, partial removal or etching off of the electrically insulating layer 14 is necessary to produce the contact portion 12b of the respective conductor track 12.

FIGS. 5a and 5b show a further possibility for reducing stray electrical fields, in which a respective electrical conductor track 12 is guided from an electrode 8 along the top side 3a of the substrate 3, more precisely along the top side of the insulator layer 13, without this resulting in stray fields E* of any significant magnitude in other waveguides 2.2, etc. In the case of the photonic circuit 1 shown in FIGS. 5a and 5b, a further insulator layer 17 is applied between the insulator layer 13 and the substrate 3, which further insulator layer is formed from an undoped semiconductor material, which in the example shown is silicon, but may also be, for example, GaAs or GaN. The further insulator layer 17 may be deposited on the substrate 3 for example epitaxially using molecular beam epitaxy (MBE), low-pressure CVD (LPCVD) or metal-organic CVD (MOCVD). Unlike what is shown in FIGS. 5a and 5b, the insulator layer 13 and the further insulator layer 17 may be made of the same material and form a common insulator layer 13, 17.

As may be seen from FIG. 5a, the insulator layer 13 has a locally limited electrically conductive volume region 18 which is limited along the front side 3a of the substrate 3 substantially to the portion 9 of the waveguide 2.1 on which the electrode 8 is mounted in order to generate the electrical field E in the waveguide 2.1. The electrically conductive volume region 18 extends in the thickness direction (Z direction) of the substrate 3 over the entire thickness D of the further insulator layer 17. By grounding the electrically conductive substrate 3, the electrically conductive volume regions 18 of the further insulator layer 17 are also grounded as far as the top side of the further insulator layer 17, such that the grounding potential is in the immediate vicinity of the underside of the portion 9 of the waveguide 2.1 in which the electrical field E is generated.

In contrast, in the case of the adjacent waveguide 2.2 shown in FIGS. 5a and 5b the distance from the substrate 3 serving as counter electrode is increased by the thickness D of the further insulator layer 17 in a portion over which the conductor track 12 runs and in which no electrode 8 is arranged. If the thickness D of the further insulator layer 17 is sufficiently large, the stray field E* by the conductor track 12 which is guided over the adjacent waveguide 2.2 is correspondingly small and has virtually no effect on the refractive index of the electro-optically active material of the adjacent waveguide 2.2, such that the effect of unwanted phase modulation by the stray field E* can be significantly reduced.

In the example shown, the further insulator layer 17 is applied epitaxially, initially undoped, to the substrate 3 (see above). The layer thickness D of the further insulator layer 17 is typically on the order of between 1 μm and 50 μm, ideally between 5 μm and 20 μm, for example approximately 10 μm. The electrically conductive volume region 18 is created by introducing suitable dopants during ion implantation only into the volume regions of the further insulator layer 17 in which the portion 9 with the respective electrode 8 for generating the electrical field E is located, this being achieved using suitable masking of the remaining further insulator layer 17, e.g., using shadow masks (usually made of metal) or using lithographically defined photoresist structures (resist masks). For the ion implantation to form the electrically conductive volume regions 18, dopants, for example with a doping concentration of between 1×10¹⁹/cm³ and 5×10¹⁹/cm³, for example of approx. 1×10¹⁹/cm³, may be introduced into the further insulator layer 17. Alternatively, the electrically conductive volume regions 18 may be created by locally limited metalization of the further insulator layer 17 which extends over the entire thickness D of the further insulator layer 17, as is the case with doping.

FIGS. 6a and 6b show another possibility for reducing stray electrical fields E* in a photonic circuit 1. In the example shown in FIGS. 6a and 6b, a respective contact surface 19, 19′ adjoins the metalization forming the electrode 8 laterally next to the respective waveguide 2.1, 2.2 at the front side 3a of the substrate 3, more precisely on the top side of the insulator layer 13. The contact surface 19, 19′ serves to establish electrical contact with a contact portion 12b of an electrical conductor track 12 extending from a wiring component in the form of a printed circuit board 20 (card) spaced apart from the front side 3a of the substrate 3 to the respective contact surface 19, as may be seen from FIG. 6a. As may also be seen from FIG. 6a, a respective horizontal wiring portion 12a of an electrical conductor track 12 runs on a side 20a of the printed circuit board 20 remote from the substrate 3, such that the printed circuit board 20 serves as a shield for the respective wiring portion 12a. The wiring portions 12a lead to a central connection point not shown in FIGS. 6a and 6b. The arrangement of the wiring portions 12a on the side 20a of the printed circuit board 20 remote from the substrate 3 is not absolutely necessary if the distance between the circuit board 20 and the substrate 3 is sufficiently large. In the example shown in FIG. 6a, the contact portion 12a of the electrical conductor track 12 takes the form of a contact pin and the electrical conductor track 12 is connected non-permanently (i.e., detachably) to the substrate 3 or to the respective contact surface 19, 19′. Alternatively, the respective contact portion 12a of a conductor track 12 may be mechanically firmly connected via a soldering point or the like to a respective contact surface 19 of the substrate 3, whereby the printed circuit board 20 is also firmly connected to the substrate 3. For this purpose, a soldering point may be applied to the respective contact surface 19 and the photonic circuit 1 may be introduced into a soldering furnace.

FIGS. 7a and 7b show a photonic circuit 1 in which, likewise, a printed circuit board 20 is used for electrically contacting conductor tracks 12 with contact surfaces 19, 19′, etc. of the substrate 3. In contrast to the example described in FIGS. 6a and 6b, the contact surfaces 19, 19′ are mounted on the side 3b of the substrate 3 remote from the waveguides 2.1, 2.2, etc. The contact surfaces 19, 19′ are contacted, as in the example described in FIGS. 6a and 6b, by way of contact portions 12b of electrical conductor tracks 12, the wiring portions 12a of which extend on a side 20a of the circuit board 20 remote from the substrate 3.

In this case, the substrate 3 is formed from an undoped semiconductor material, e.g., from silicon, and has locally limited electrically conductive volume regions 21, the width of which corresponds approximately to the width of the waveguides 2.1, 2.2, etc. and which are limited in the longitudinal direction of the waveguides 2.1, 2.2, etc. to the portion 9, 9′, etc. in which an electrical field is to be generated. The semiconductor material is doped only in the electrically conductive volume regions 21 and is electrically conductive only in these regions. The electrically conductive volume regions 21 are electrically conductively connected to the respective contact surface 9, 9′, etc. on the back side 3b of the substrate 3. In order to establish the electrically conductive connection, recesses 22 in the form of blind holes are introduced into the substrate 3, these extending from the back side 3b of the substrate 3 to a respective electrically conductive volume region 21. In the example shown in FIGS. 7a and 7b, the electrodes 8 are therefore formed by a respective metalization layer extending from a respective contact surface 19, 19′ to the respective electrically conductive volume region 21. The thickness of a respective electrically conductive volume region 21 is on the order of the thickness D of the further insulator layer 17 of FIG. 5a. In the example shown, the metalization layer extends over the entire surface of a respective recess 22, but this is not absolutely necessary. The recesses 22 may be etched into the substrate 3 using suitable etching methods, e.g., by DRIE, wherein the region in which the recesses 22 are produced may be defined lithographically, for example.

In the example shown in FIGS. 7a and 7b, the above-described insulator layer 13, of SiO₂ or SiN for example, is applied flat on the side 3a of the substrate 3 facing the waveguides 2.1-2N and a metalization layer 23 is then deposited over the entire surface of the insulator layer 13. As indicated in FIG. 7a, the metalization layer 23 is grounded and forms the counter electrode for the electrodes 8 manufactured in the manner described above.

In summary, a photonic circuit may be produced in the manner described above which enables extensive wiring of a large number of phase modulators 6a-c or other electro-optical modulators which are mounted on a common substrate 3, without the stray electrical fields E* which inevitably occur in the process causing unwanted modulations of the photons P1, P2-PN guided in the waveguides 2.1, 2.2-2.N.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A photonic circuit, comprising:
a substrate,
a plurality of waveguides mounted on the substrate, and
a plurality of modulators for modulating light guided in the waveguides,
wherein the plurality of waveguides is formed from an electro-optically active material, the modulators are electro-optical modulators, each modulator comprises an electrode for generating an electrical field in a portion of a respective waveguide, and each modulator comprises a conductor track for feeding an electrical modulation signal to the electrode, and
the photonic circuit is configured to reduce stray electrical fields in the plurality of waveguides by feeding the electrical modulation signals to the electrodes.

2. The photonic circuit according to claim 1, further comprising an electrically conductive shield for shielding the plurality of waveguides from the stray electrical fields, wherein the electrically conductive shield is arranged between a wiring portion of a respective conductor track and the plurality of waveguides.

3. The photonic circuit according to claim 2, wherein the plurality of waveguides is embedded in an electrically insulating layer, wherein the wiring portions of the electrical conductor tracks extend on a side of the electrically insulating layer remote from a respective waveguide, and wherein the electrically conductive shield is embedded in the electrically insulating layer.

4. The photonic circuit according to claim 2, wherein the electrically conductive shield has a hole in a region of the electrode of a respective modulator, and wherein a connecting portion of the conductor track of the respective modulator runs through the hole.

5. The photonic circuit according to claim 1, wherein the substrate is electrically conductive.

6. The photonic circuit according to claim 5, further comprising an insulator layer applied to a side of the substrate facing the plurality of waveguides, wherein the insulator layer extends between the plurality of waveguides and the substrate and surrounds the plurality of waveguides.

7. The photonic circuit according to claim 5, further comprising a further insulator layer applied between the substrate and the insulator layer, wherein the insulator layer or the further insulator layer defines electrically conductive regions, wherein each conductive region extends between the portion of the respective waveguide and the substrate.

8. The photonic circuit according to claim 7, wherein the insulator layer or the further insulator layer has a thickness of between 1 μm and 50 μm.

9. The photonic circuit according to claim 7, wherein at least one conductor track on the substrate is guided over at least one of the plurality of waveguides.

10. The photonic circuit according to claim 1, wherein the substrate has a contact surface in a region of a respective electrode for electrically contacting with a contact portion of a respective conductor track, wherein the contact portion extends from a wiring component spaced apart from the substrate to the contact surface.

11. The photonic circuit according to claim 10, wherein wiring portions of the conductor tracks run on a side of the wiring component remote from the substrate.

12. The photonic circuit according to claim 10, wherein the contact surfaces are mounted on a side of the substrate facing the plurality of waveguides.

13. The photonic circuit according to claim 10, wherein the contact surfaces are mounted on a side of the substrate remote from the plurality of waveguides.

14. The photonic circuit according to claim 13, wherein the substrate is electrically insulating and defines electrically conductive volume regions which are electrically conductively connected to a respective contact surface on the side of the substrate remote from the plurality of waveguides.

15. The photonic circuit according to claim 14, wherein the electrically conductive volume regions adjoin recesses which extend into the substrate from the side of the substrate remote from the plurality of waveguides, wherein the electrodes are formed by a metalization layer extending from a respective contact surface to a respective electrically conductive volume region.
